(19) United States
(12) Patent Application Publication
(10) Pub. No.: US 2016/0098882 A1
(43) Pub. Date: Apr. 7, 2016

(54) SYSTEM AND METHOD TO ENABLE RULES-RESTRICTED VENDING MACHINE PURCHASES

(71) Applicant: CapTech Ventures, Inc., Richmond, VA (US)

(72) Inventors: Stephen Thomas Holdych, Richmond, VA (US); George Edward Cox, JR., Henrico, VA (US); Vincent Brett Schoenfelder, Midlothian, VA (US); Samuel Grayson Gorman, Midlothian, VA (US); David Eugene Tiller, Glen Allen, VA (US)

(73) Assignee: CapTech Ventures, Inc., Richmond, VA (US)

(21) Appl. No.: 14/874,822

(22) Filed: Oct. 5, 2015

Related U.S. Application Data
(60) Provisional application No. 62/060,644, filed on Oct. 7, 2014.

(51) Int. Cl. G07F 7/00; G07F 9/10; G07F 9/00; G06Q 20/32; G06Q 20/18

(52) U.S. Cl. CPC G07F 7/005; G06Q 20/327; G06Q 20/18; G07F 9/006; G07F 9/10

(57) ABSTRACT

A method and system that allows a self-standing vending machine to distribute controlled goods only to authorized purchasers wherein the authorization and purchase occurs via the purchaser's mobile computing device. The invention allows the purchaser to locate products, get information about products, and purchase products using their mobile phone and receive those products at a specified vending machine. The system uses information provided by the purchaser and possibly information from 3^{rd} party sources to authorize the purchase of the controlled item.

This application claims the benefit of U.S. Provisional Patent Application No. 62/060,644 filed Oct. 7, 2014, incorporated by reference herein in its entirety.

A machine and system enable the sale and immediate distribution of rules-restricted products to authorized purchasers through the use of mobile computers with automated verification.

### BACKGROUND

At present, the sale of controlled products through the use of vending machines is achieved by age verification found either on a fixed machine control pad or through the use of cameras that are attached to the vending machine and supported remotely by a third party. The products are visible in or otherwise clearly advertised on the individual machines. FIG. 1 is an illustration of a conventional, prior art vending machine.

Additionally, current vending machines are typically independent, so a purchaser needs to literally walk up to a vending machine to see what is for sale or, alternatively, remember where a vending machine is located that sells product that the prospective purchaser wants to buy. Furthermore, the immediate availability of a product in the vending machine is unknown until the machine is approached directly.

Finally, many rules-restricted products, by their very fundamental restricted nature, have limited marketing and advertising options. For instance, some products are not allowed to be publicly displayed in all locations. As a result, many rules-restricted products are simply not available for sale from public vending machines.

### SUMMARY

Accordingly, it is an object of the present invention to overcome the foregoing drawbacks and limitations of current vending machine systems. The vending machine system described herein connects mobile devices with a vending machine or machines to facilitate the purchase of both unrestricted and/or rules-restricted merchandise from the machine. Through direct and/or indirect communication between the mobile device and the vending machine, a purchaser may identify and reserve or purchase a product from the vending machine that may or may not be visible from the outside of the vending machine.

In one example, a vending machine system enables the purchase and delivery of rules-restricted merchandise. The system comprises a vending machine and a mobile device. The vending machine includes a secure cabinet having merchandise stored therein, wherein the merchandise comprises rules-restricted merchandise that is not visible from the outside of the cabinet. The cabinet further includes a controller, a dispensing mechanism and an access port. The controller is adapted to actuate the dispensing mechanism to transfer merchandise from inside the cabinet to the access port, wherein the access port is open to the outside of the cabinet. The controller comprises a transceiver adapted to transmit and receive wireless communication signals. The mobile device comprises an electronic unique identifier that includes an authorization for eligibility to purchase the rules-restricted merchandise. The mobile device further comprises a user interface and a transceiver adapted to transmit and receive wireless communication signals. The controller and the mobile device are wirelessly connected to exchange communications signals. The controller is adapted to dispense rules-restricted merchandise to the access port upon confirmation of receipt of an eligibility signal from the mobile device.

Alternatively, the vending machine system may further comprise a service orchestrator that is operatively linked to the mobile device and/or to the vending machine. The service orchestrator comprises a transceiver for exchanging communication signals with the mobile device and/or the vending machine controller, wherein the service orchestrator comprises a payment engine that records and authorizes by a communication signal the financial payment for vending machine merchandise by the mobile device. The vending machine controller may comprise a merchandise inventory record that is in turn transmitted to and stored in the service orchestrator. The service orchestrator may comprise a location service engine that is adapted to communicate with the mobile device to deliver location information regarding the vending machine to the mobile device. The service orchestrator may also comprise an eligibility engine, wherein the eligibility engine comprises a record of electronic unique identifiers and their corresponding authorization for the purchase of rules-restricted merchandise. The service orchestrator may be operatively linked to both the vending machine and the mobile device.

The mobile device may comprise a user interface that displays merchandise in the vending machine that is available for sale to a user of the mobile device. All of the merchandise stored in the vending machine cabinet may be rules-restricted merchandise. In one example, none of the merchandise in the vending machine cabinet is visible from outside the cabinet. The vending machine may comprise no user interface on the outside surface of the cabinet that relates to a purchase of merchandise stored inside the cabinet. The vending machine controller may only actuate dispensing of merchandise to the access port if the mobile device is proximate the vending machine. The merchandise in the vending machine may comprise unrestricted merchandise, and that unrestricted merchandise may be visible from outside the cabinet. The vending machine may comprise a dispensing sensor that validates that a customer has received the dispensed merchandise, and the sensor may be selected from the group consisting of a motion sensor, a camera, a heat sensor, a weight scale, and door open sensor. The vending machine controller may comprise a vending machine service history and service dispatcher for monitoring and ordering a service call to the vending machine.

In another example, a vending machine system for enabling to purchase and delivery of rules-restricted merchandise includes a vending machine and a mobile device. The vending machine comprises a secure cabinet having merchandise stored therein, wherein the merchandise comprises rules-restricted merchandise that is not visible from the outside of the cabinet. The cabinet comprises a controller, a dispensing mechanism and an access port, wherein the controller is adapted to actuate the dispensing mechanism to transfer merchandise from inside the cabinet to the access port, wherein the access port is open to the outside of the cabinet. The controller comprises a transceiver adapted to transmit and receive wireless communications signals. The mobile device comprises an electronic unique identifier that includes an authorization for eligibility to purchase the rules-restricted merchandise. The mobile device includes a user interface and a transceiver adapted to transmit and receive wireless communications signals. The vending machine system further comprises a service orchestrator that is operatively linked to the mobile device and to the vending machine, wherein the service orchestrator comprises a transceiver for exchanging communications signals with the mobile device and the vending machine controller. The controller and the mobile device are each connected and communicate with each other through the service orchestrator. The controller is adapted to dispense rules-restricted merchandise to the access port upon confirmation of receipt of an eligibility signal from the mobile device.

### BRIEF DESCRIPTION OF THE DRAWINGS

FIG. 1 illustrates a current vending machine generally, wherein the machine displays the product through a display window and the purchaser requires no authentication or verification to make a purchase and receive product.

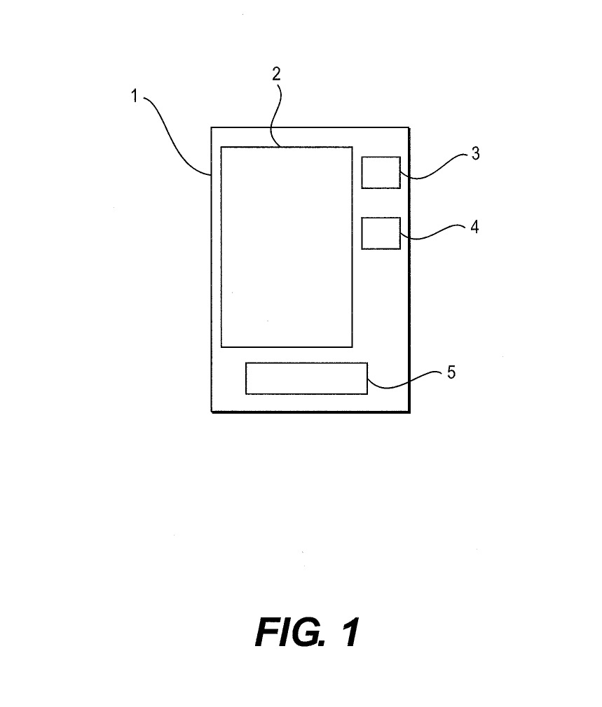

FIG. 2 illustrates a possible system functional architecture for a first example of the system and method described herein. The vending machine communicates to a set of central systems that manage inventory, identify customers, remit payment, and authorize purchases. All of the components communicate via wireless or wired data communications protocols. Any of the systems may communicate with other systems to provide operational management information, or analytics information. This figure illustrates an example where the vending machine and mobile computer both have connections to the service and can communicate with one another.

FIG. 3 illustrates a second embodiment of the system and method wherein the mobile device does not have a wide area data link to the vending services. In this example all of the communications to the mobile computer are relayed through the vending machine.

FIG. 4 illustrates a third example of the system and method wherein the vending machine does not have a wide area data link to the vending services. Instead, the vending machine proxies its data requests through the mobile computer.

FIG. 5 illustrates a fourth example of the system and method wherein both the vending machine and the mobile computer are able to communicate with the vending services but have no ability to communicate with each other. An example of this type of scenario would be one where the mobile computer user has disabled the mobile computer Bluetooth wireless interface.

FIG. 6 illustrates a fifth example wherein neither the user's mobile computer or the vending machine have a wide area data link. In this embodiment the mobile computer and vending machine must securely negotiate a peer-to-peer connection and purchase information must be securely packaged for later secure forwarding to the vending service via either the mobile computer, the vending machine, or via a 3^{rd} party.

FIG. 7 contains a sequence diagram pursuant to the system and method described herein that illustrates an in-depth sequence of events for a customer purchasing a rules-restricted item. The customer uses their own mobile computing device to identify, select, and purchase the item. The services validate, remit, and record the purchase and instruct the machine to immediately distribute the purchased items.

FIG. 8 provides a sequence diagram that illustrates a simplified purchase flow for a customer making a rules-restricted purchase. The mobile device locates a machine with the desired product, and requests permission to purchase the product. The services validate, authorize, remit, record, and direct the distribution of the product.

FIG. 9 is a perspective view of an example of a vending machine as described herein.

FIG. 10 is a perspective view of the vending machine with an interior drawer partially pulled out from the case of the vending machine.

FIG. 11 is a perspective view of the drawer that is mounted so as to slide inside the vending machine.

Table of Reference Numerals in Drawings

| Reference Numeral | Description |
|---|---|
| 1 -- | Traditional non-connected vending machine. Free standing |
| | machine that contains product inventory. Customer uses the |
| | product display viewport to query machine inventory and select |
| | product. No verification of customer permission to purchase |
| | product is possible. |
| 2 -- | Product display viewport. Customer views products through |
| | the viewport to both select product and query device inventory. |
| 3 -- | Product selection interface. Customer enters inventory slot |
| | identifier to make a purchase selection. |
| 4 -- | Payment remittance interface. Customer uses cash or credit |
| | card to remit payment for selected item. Machine may dispense |
| | change via the remittance interface. |
| 5 -- | Product dispensing receptacle. After selecting item and |
| | making remittance the machine dispenses the purchased product |
| | through this receptacle. |
| 103 -- | Connected rules-restricted product vending machine. |
| | Connects to the internet to provide payment, authorization, and |
| | marketing services for the products in the machine. |
| 11 -- | Opaque product storage area. Product is stored behind |
| | opaque cover to prevent product marketing to unauthorized |
| | persons. |
| 12 -- | Machine status indicator. A simple indicator of the machine's |
| | status which may be in-order, out-of-order, service-tech-called, |
| | etc. |
| 13 -- | Machine proximity radio. Invisibly advertises the presence |
| | and identity of the machine to mobile computers in close |
| | proximity. |
| 14 -- | Long distance communication module. Provides long-range |
| | communication to the central authorization and payment |
| | systems via physical wiring or wireless telecommunications. |
| 15 -- | Product access port. Provides access to the dispensed product |
| | and verifies that the customer has received the product. |
| 16 -- | Wide Area Communication Links. Provides connectivity |
| | from the mobile computer or vending machine to the |
| | authorization and payment services. |
| 17 -- | Mobile Device to Vending Machine Link. Provides short |
| | range data interchange directly between the mobile computer |
| | and the vending machine. In some examples this connection |
| | also proxies the wide area communication data from a network |
| | peer that does not have a dedicated wide area communication |
| | link. |
| 100 -- | Vending Services. The collection of network services required |
| | to identify users, authorize purchases, execute transactions, |
| | record transaction history, and control vending machines. |
| 110 -- | Service Orchestrator. Manages the connection to the vending |
| | device and the customer's mobile devices, and coordinates the |
| | remote interactions with the other central components of the |
| | system. |
| 111 -- | Location Service. Provides information about the location of |
| | smart vending machines to requesting devices. The information |
| | provided may be filtered by the machines that have product for |
| | which the customer is authorized to purchase. |
| 112 -- | CRM, or Customer relationship management. This system |
| | contains information about each registered customer including |
| | demographic information, activity history, and product |
| | preferences. |
| 113 -- | TX Register. Contains history of every financial transaction |
| | conducted by the system. |
| 114 -- | Eligibility Engine. Executes a set of business rules specific to |
| | the product being vended and the customer making the purchase |
| | to determine if the customer is authorized to make the purchase. |
| 115 -- | Payment Engine. Interfaces with payment processing systems, |
| | like banks, to authorize and remit payments for products. |
| 116 -- | Inventory. Maintains inventory information for each machine. |
| 117 -- | Machine Control. Maintains information about each machine |
| | and generates commands to control the activities of the |
| | machine. |
| 101 -- | Mobile Device. The customer's computer, usually a handheld |
| | phone, that provides a user interface to the machine and allows |
| | the customer to select and purchase authorized products from a |
| | machine. |
| 118 -- | UI, or User Interface. The user interface on the mobile device |
| | that communicates product information and allows the customer |
| | to purchase authorized products from a proximate machine. |
| 200 -- | Prototype Vending Machine. An implementation of the device |
| | that exhibits one of many possible configurations. |
| 202 -- | Front Panel. An opaque panel that limits access to the contents |
| | of the device. |
| 204 -- | Access Port. An opening thru which the customer may access |
| | vended products. |
| 206 -- | Back Panel. An opaque panel that limits access to the contents |
| | of the device, with openings for power a switch and optional |
| | external power. |
| 210 -- | Drawer. A removable assembly that supports the internal |
| | components of the machine that are involved in the physical |
| | vending of products. |
| 215, 217, 219 -- | Troughs. Assemblies with a rectangular cross-section that hold |
| | the products to be vended. Each trough has an associated wire |
| | spiral that moves products toward the end of the trough when |
| | rotated. |
| 220, 222, 224 -- | Motor Nut. A small plastic or metal assembly that connects to |
| | the motor and protrudes through the back wall of each trough. |
| | The motor nut is connected to the wire spiral that physically |
| | moves products down the trough toward the access port. |
| 225 -- | Machine Controller. A small, embedded computer with |
| | associated ancillary electronic components that perform all |
| | communication, logic, and physical interface functions of the |
| | device. |
| 227 -- | Battery. A rechargeable power source that provides all power |
| | to the device. |
| 230 -- | Slide. An inclined plane that shepherds products that drop from |
| | the troughs toward the access port. |

### DETAILED DESCRIPTION

The present invention is a vending machine system to conveniently and safely make products available through one or more vending machines placed in strategic locations for convenience of consumers. By using a mobile device, a consumer user can locate a proximate vending machine that offers for sale a desired product. The vending machine would be unmarked or modestly marked so that the products inside are partially or completely hidden from view. Instead, an item or menu of items is displayed on the mobile device user interface. The transaction is completed electronically with authorization and payment features, among others, managed to insure authorized transactions and payment for the products.

Throughout this description, the term “vending machine” is used and is intended to be used broadly. A vending machine is broadly a device for dispensing products. It is not limited to the look and structure of existing, conventional vending machines. The new features described herein may enable new and unique shapes and constructions of vending machines.

Also, the term “rules-restricted merchandise” is used throughout this description. Rules-restricted merchandise refers to any products that have legal, regulatory, social or vending-optional rules and limitations regarding purchase. Examples include the offer for sale and sale of alcohol, tobacco, prescription drugs, ammunition and marijuana which have state and local laws and associated regulations with respect to sales. Other rules, however, might include limitations with respect to time of sale, frequency of sale, or specific products where sales restrictions are imposed by a vending or community policies. Other rules of course may be developed and applied to products offered for sale by the vending machine system described herein.

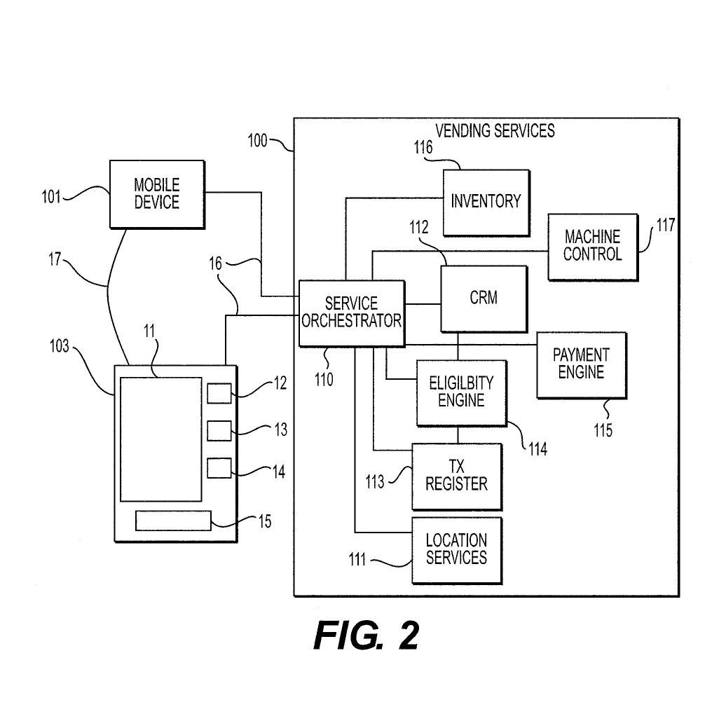

FIG. 2 shows the components involved in one example of the present invention. As a prospective customer or user approaches the vicinity of a vending machine (103), the customer's mobile device (101) alerts the customer to the presence of the vending machine. The vending machine (103) contains dispensable product and a connection between the customer, inventory, and eligibility system. The vending machine (103) does not provide any product information or selection mechanism to the user. All product information is conveyed to the user via the user's mobile device (101) user interface (118). This allows the system to only communicate to the customer the products that are available for purchase and for which the customer is eligible to purchase. The interface can also provide targeted information to the customer based on customer preferences or prior purchase history. The vending machine (103) is responsible for securing and dispensing products. All of the decisions about eligibility and the remittance of payment are conducted by the vending services (100). Having product information available via the mobile device (101) allows customers to purchase and reserve product before they get to a machine, or to not waste time stopping at a machine that has no suitable product. The machine may not provide visibility to the product so as to comply with rules and/or regulations preventing the marketing of restricted products to ineligible purchasers.

The customer mobile device (101) communicates with the service orchestrator (110) in the vending services (100) to determine the available inventory in the machine. The service orchestrator (110) acts as a single point-of-contact for all communications between the mobile device (103) and the vending services (110). Acting as a single point-of-contact allows implementation details to be hidden from the mobile device (101) and simplifies those communications. Hiding these details allows them to be changed without impacting the installed base of vending machines. The vending machines (103) also communicate with the vending services (100) through the service orchestrator (110).

The service orchestrator (110) uses information from the location services (111), CRM system (112), inventory control (116) and the eligibility engine (114) to determine what products should be presented to the customer. Any of these systems may be located within or externally to the vending machine.

The location services (111) manages geo-spatial and other information that allows customers to locate and identify machines. Location information may be expressed in latitude-longitude where that information is available. It may also be expressed in the terms of a unique beacon identifier if the machine is advertising itself via a short-range wireless communication system like Bluetooth Low Energy (BTLE) or WiFi-Aware. The customer's mobile device (101) can ask the location services for all machines within a certain distance of a set of coordinates. It may also provide a machine identifier detected via BTLE and ask the location service about details of that machine. The mobile device may then present the available products to purchase.

The CRM system (112) contains information about the current customer. This may include demographic data, personal preferences, or marketing data. This data may be used to customize information presented to the user via their mobile device or to offer special deals to the customer. The data may also be used to verify the eligibility to purchase products.

The eligibility system (114) applies rules to the provided data to determine if a customer is allowed to purchase a product. The rules may be applied to CRM data, past purchase history, or machine location to make this determination. For example, the eligibility system may consider the age of the customer, the type of product, and the location of the machine to make the determination. The determination of eligibility will be made upon request based on the current data provided.

The inventory control system (116) maintains product inventory levels and information for vending machines within the system. The inventory information must be precise to the slot within the vending machine. As products are reserved or purchased the inventory levels are reduced. As reservations are cancelled or personnel replenish the machine inventory levels are increased. Information about items in the machine may include, brand, model, nutrition information, item age, serial number, and SKU.

If the customer wishes to purchase one or more products he/she selects the products using the mobile device user interface (118). Once the user selects the products and confirms the purchase the mobile device (101) communicates with the service orchestrator (110) to execute the purchase. The orchestrator uses the CRM system (112) to identify the customer, eligibility system (114) to verify that the customer has right to purchase the product, inventory (116) to make sure the product is in stock, the payment engine (115) to remit payment electronically, the transaction register (113) to record the transaction, and the machine control (117) to instruct the machine (103) to dispense the product. The orchestrator then informs the customer via data sent to the mobile device and displayed on the user interface that the transaction has been complete. The machine controller then may monitor for product pickup by the customer. The machine controller may reverse the transaction if the product is not retrieved within a certain period of time.

The payment engine (115) interfaces with 3^{rd} party payment providers to charge the customers payment instrument for the items purchased. The payment engine may interface with multiple payments concurrently, depending on the payment instrument registered for the customer. The payment engine provides confirmation of payment to the service orchestrator.

The transaction register records the purchases made by every customer. This information may include the product purchased, information about that product (for example, product serial number), date and time of purchase, purchasing customer, and the payment transaction. This information may be used for reporting, marketing, or eligibility determination.

The machine control (117) system understands the different capabilities of the vending machines (103) in the system and constructs appropriate commands for those systems to dispense product. The system can also send status messages to the machine controller so that it may parse the status message (which may vary by machine brand) and act accordingly. For example, a machine may report a malfunction wherein the machine controller will dispatch a repair technician to repair the machine and it will mark the machine as unavailable. The machine controller may also keep a history of use of the machine and maintain maintenance schedules for the machines.

The responsibilities of the mobile device (101) include presenting a user interface (118) to the user to select products and see product information, providing customer identity information to the other components of the system, notifing the user of the location of vending machines containing approved products, and alerting the customer to transaction status.

The responsibilities of the vending machine (103) include: securely contain product before it is purchased, dispense products based on instructions from the machine control system (117), and register the receipt of the dispensed product.

The other components of the system are responsible for maintaining customer information, approving individual purchases by a customer, maintaining inventory status of machines, remitting payment, recording transactions, and maintaining information about machine location.

Prior registration of a potential customer involves the customer providing identification and payment information to the CRM system (112). Using this data, the system collects information required to perform purchase eligibility checks for future purchases. Pre-registration may occur using one of several methods: via a mobile device, via an Internet connected computer, via postal mail, or via voice telephone.

When a user wants to know where he/she may purchase an item they may use their mobile device to query the system. The mobile device (101) sends the service orchestrator (110) information about the type of product sought and the location of the prospective customer. The service orchestrator then may then call the location services (111) to get an inventory of the machines within a specific distance to the user. Once the set of possible machines is returned to the service orchestrator it then calls the CRM system (112) to retrieve information about the customer. The service orchestrator also calls the inventory system (116) and transaction register (113) to get inventory levels and purchase history for the user. This information is then provided to the eligibility engine (114) which reduces the set of possible machines to only those that have products for which the customer is eligible to purchase. The set of potential machines is then returned to the requesting mobile device (101).

If the customer comes within a short distance of a machine, 50 meters for example, the customer mobile device (101) may detect a wireless beacon announcing the presence of the machine. The customer mobile device (101) may then send to the service orchestrator (110) the customer identifier and the encountered machine identifier. The service orchestrator uses the machine ID to retrieve information about that machine. Then the service orchestrator calls the CRM system (112) to retrieve information about the customer. The service orchestrator also calls the inventory system (116) and transaction register (113) to get inventory levels and purchase history for the user. This information is then provided to the eligibility engine (114) which identifies the products for which the customer is eligible to purchase from that machine. The set of potential products is then returned to the requesting mobile device. The mobile device may then alert the customer to the presence of eligible products located within the nearby machine.

When the customer decides to purchase an item from a machine (103) he signals that through the user interface (118) of their mobile device (101). The mobile device contacts the service orchestrator (110) with the purchase request that contains the customer identifier, and product identifiers the customer wishes to purchase. The service orchestrator (110) then checks the eligibility of the customer by querying the CRM system (112) for customer data and transaction register (113) for past purchase history. This information is provided to the eligibility engine (114) which applies eligibility rules and returns the eligibility status to the orchestrator. If the customer is not eligible then a denial status is returned to the customer mobile device. If the customer is eligible then the service orchestrator sends a remittance request to the payment engine (115) to request electronic payment for the products. The payment engine returns either the transaction identifier for a successful payment or a payment denial. If the payment is denied then that information is returned to the customer mobile device. If the payment is successful then the transaction is recorded in the transaction register (113) and the service orchestrator sends a request to the machine control component (117) to direct dispensing of the product to an access port. It also replies to the customer mobile device that the purchase has been approved and the item will be dispensed immediately. The service orchestrator also sends a purchase receipt to the customer mobile device and it may send the receipt through other channels, such as email. The machine then monitors its access port for access to the product. When the product is retrieved by the customer a pickup notification is sent by the machine back to the machine controller to record that the customer retrieved the purchased item.

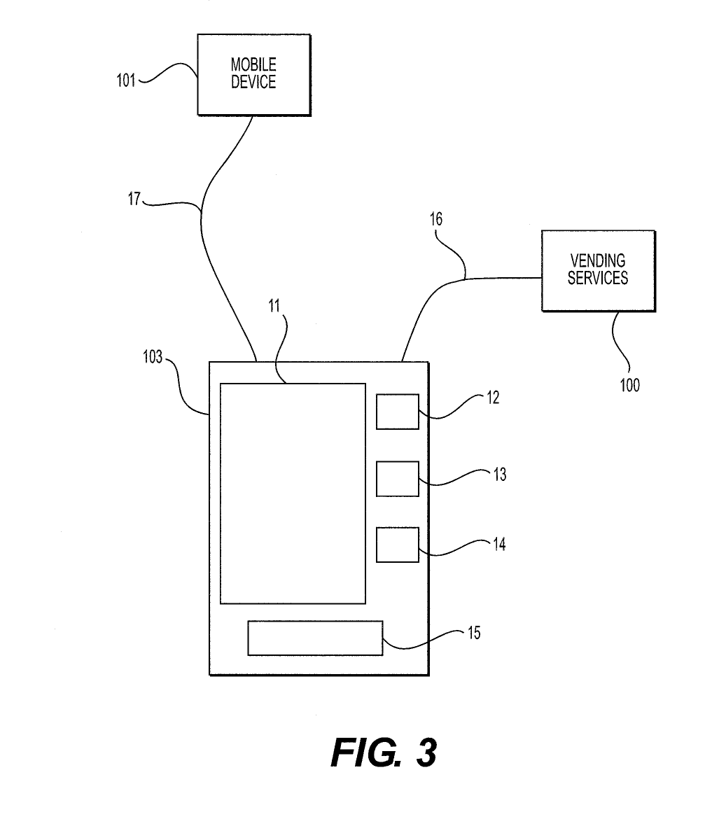

FIG. 3 illustrates a variation of the method for authorizing and vending items. In this example, the mobile computer (101) does not have a connection to the vending services. In this example, the mobile computer (101) communicates through the vending machine (103) via the peer-to-peer data link (17) between the mobile computer and the vending machine. The vending machine (103) provides available inventory information directly to the mobile computer.

In this example, as the user approaches the vending machine, the machine retrieves user information from the user's mobile computer (101). It communicates that information to the vending services (100) via the wide area data link (16), which returns the set of available products for that user. The vending machine then communicates the available inventory to the mobile computer which displays the information to the user.

The user can then a make product selection and execute the product purchase. Once an item is purchased the vending machine communicates those selections to the vending services where the purchase is authorized, and if permissible, the machine is instructed to distribute the product.

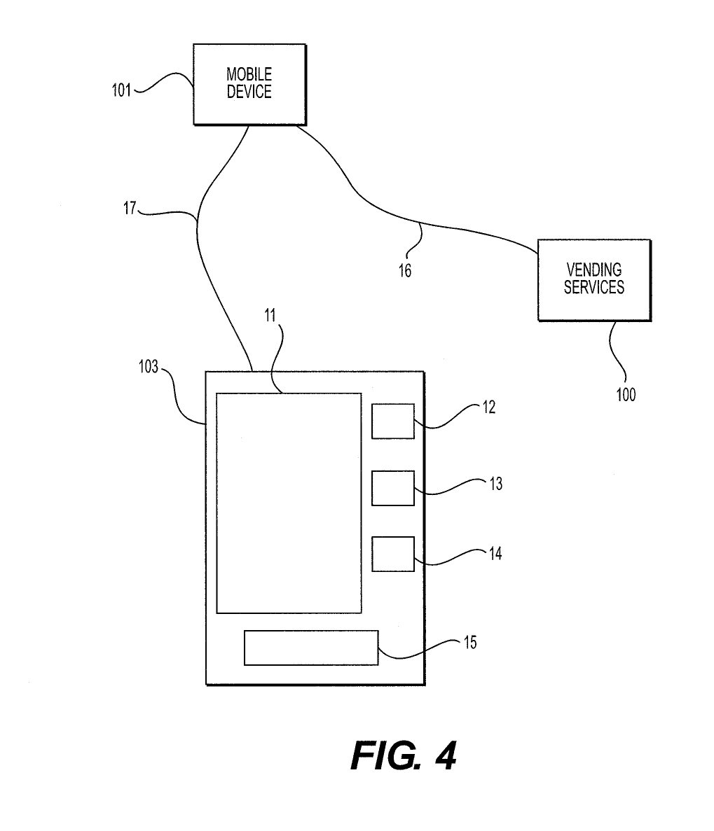

FIG. 4 illustrates a variation of the system wherein the vending machine does not have a wide area data link. The vending machine communicates through the peer-to-peer connection to the mobile computer (17) to communicate with the vending services (100).

As the user approaches the vending machine (103) the user's mobile computer (101) and vending machine establish a temporary peer-to-peer data connection (17). The vending machine (103) communicates identification information through the mobile computer (101). The user's mobile computer (101) communicates with the vending services (100) to select and purchase product. Once the purchase has been completed the mobile computer transmits a secure data packet to the vending machine instructing the machine to distribute the purchased product. The vending machine may use the temporary peer-to-peer data connection to transmit status information to the vending services and to receive updated information from those services.

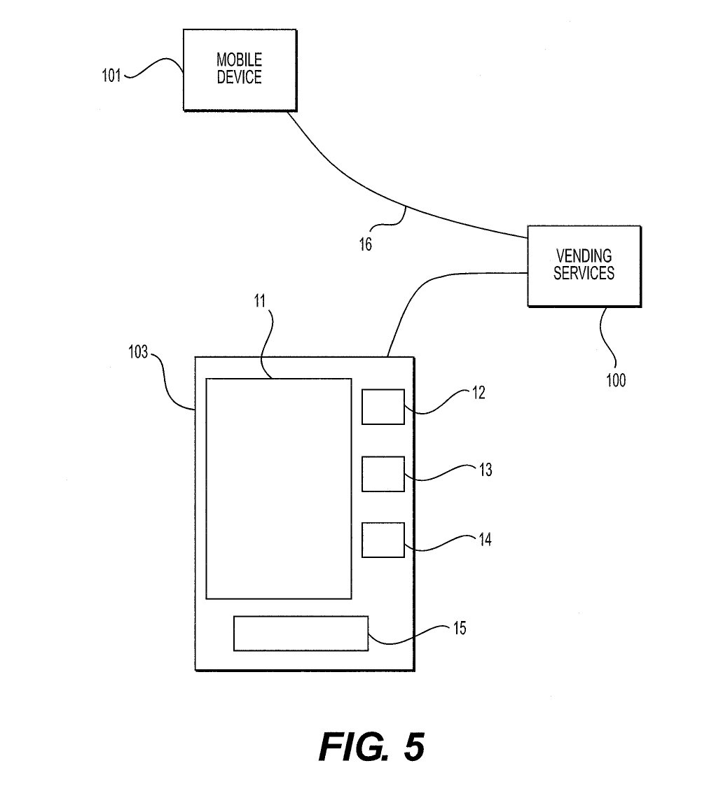

FIG. 5 illustrates a still further variation on the system where the user's mobile computer and vending machine do not create a peer-to-peer data connection. In this example, the user's mobile computer (101) communicates with the vending services (100) to determine product available, make product selections, and to complete the purchase. The vending services (100) communicate directly with the vending machine (103) instructing it to vend purchased product.

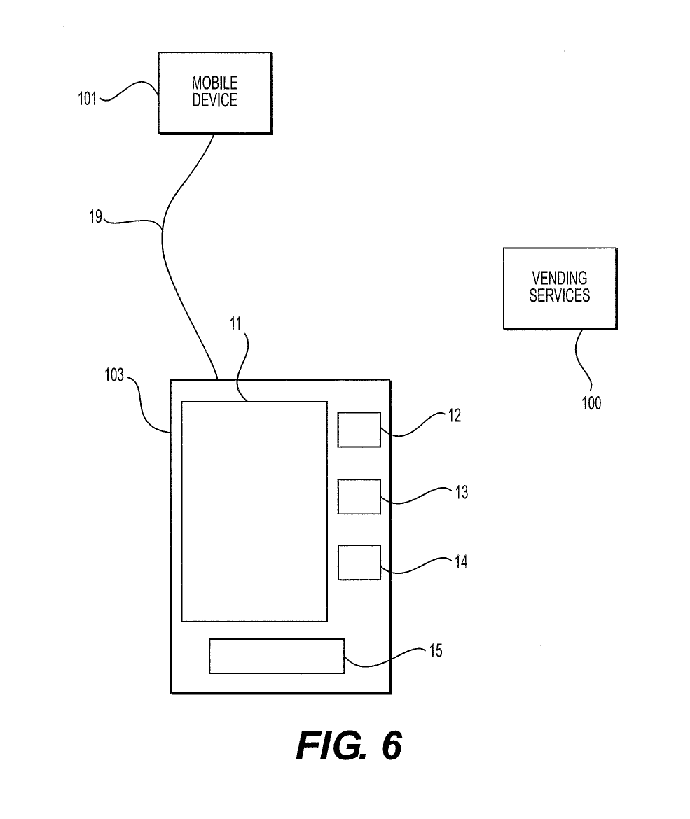

FIG. 6 illustrates an example of the system in which neither the user's mobile computer nor the vending machine have a connection to vending services. In this example, the user pre-authorizes the purchase of specific items. The pre-authorization information is stored securely on the user's mobile computer in a form that cannot be modified without detection. In this example, the user can browse and select products to purchase at any time the device has a connection to the vending services. When a product is selected, the purchase authorized, and tendered, the vending services deliver to the mobile computer a cryptographically secure token representing that purchase.

When the user's mobile computer approaches a vending machine the mobile computer (101) establishes a secure connection (19) with the vending machine (103). The vending machine provides to the mobile computer information about the items it has available for purchase. The mobile computer compares this information to the set of purchase tokens stored within itself. If a secure token authorizes the purchase of an item from the current proximate vending machine, the mobile computer presents that product to the user as an item that may be purchased.

When the user selects an item to be purchased the mobile computer communicates that purchase information and the authorizing secure token to the vending machine via the peer-to-peer data link (19). The vending machine verifies the cryptographic integrity of the token and validates that the token authorizes the purchase of the selected product. If the purchase is allowed, then the vending machine distributes the product and keeps a transaction log of the purchase. The transaction log includes the product purchased and the secure token provided to make the purchase. At a future time, a trusted 3^{rd} party retrieves the transaction log and communicates that log to the vending services. In an alternate example, the transaction log is encrypted, secured against modification, and stored on the user's mobile computer. When the mobile computer is next able to communicate with the vending service it transmits the secure transaction log.

When the vending services receive the transaction log, the transactions contained therein are reconciled against the customer's account(s). Additional fraud detection is applied to detect fraudulent purchase activity.

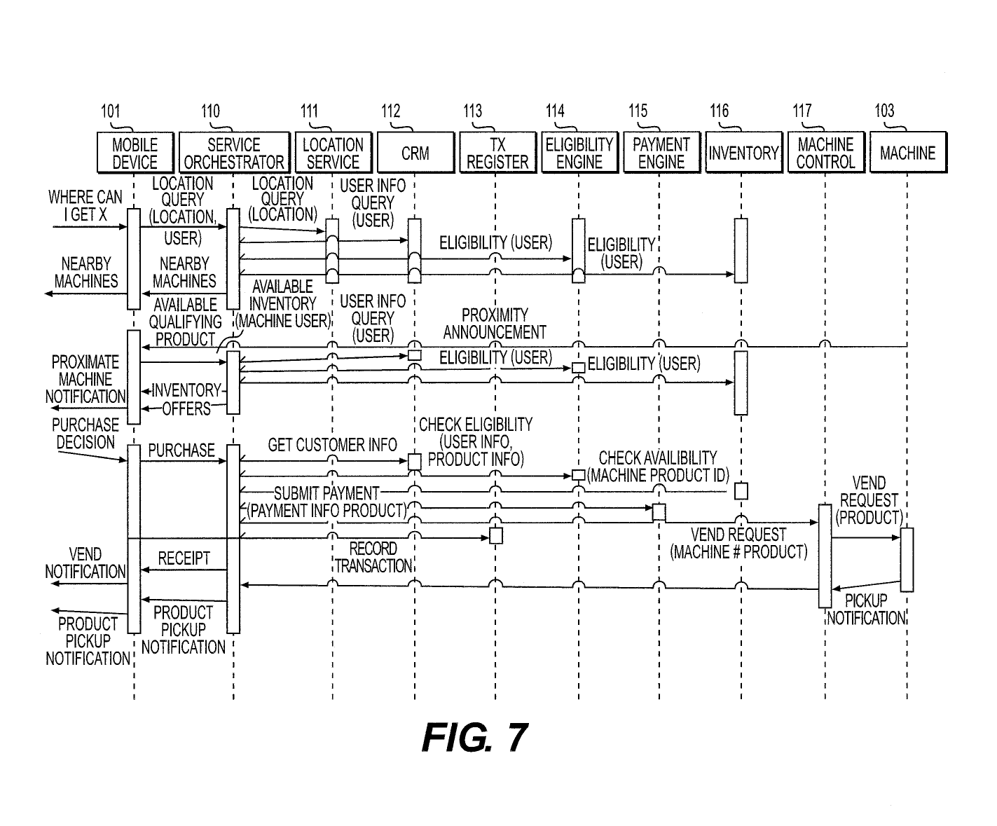

Turning now to FIG. 7, there is shown a reasonably in-depth sequence diagram that identifies the sequence of events for a customer purchasing a rules-restricted item as described herein. The user deploys the mobile device (101) in an attempt to purchase product from a vending machine (103). The vending machine (103) is operated by a machine controller (117). The remaining functional modules are all found in the vending services processor (100). The vending services processor (100) may be one or more processors that operate alone or together to deliver the various individual services. The functional components of the vending services processor (100) include a service orchestrator (110), a location service module (111), a customer relationship management (CRM) module (112), a transaction register (113), an eligibility engine (114), a payment engine (115) and an inventory module (116). Each of these functional modules maybe found on the same or different computer processor units. Each of these functional modules may also be individually customer-programmed to meet any specific purchase requirements or scenarios. In FIG. 7, the very simple purchase of a product “X” is illustrated through to the product pick up notification and sale notification under the mobile device (101).

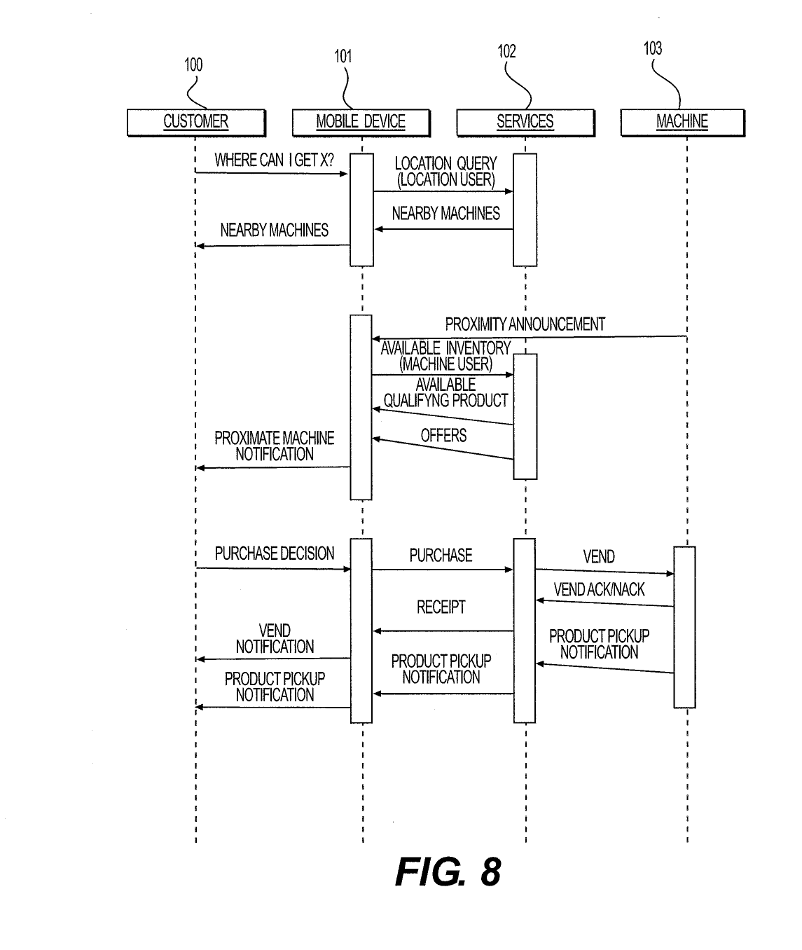

FIG. 8 is a more simplified purchase flow for a customer (100) using their mobile device (101) to purchase product from a machine (103). The vending services (102) are simplified as a single function in FIG. 8.

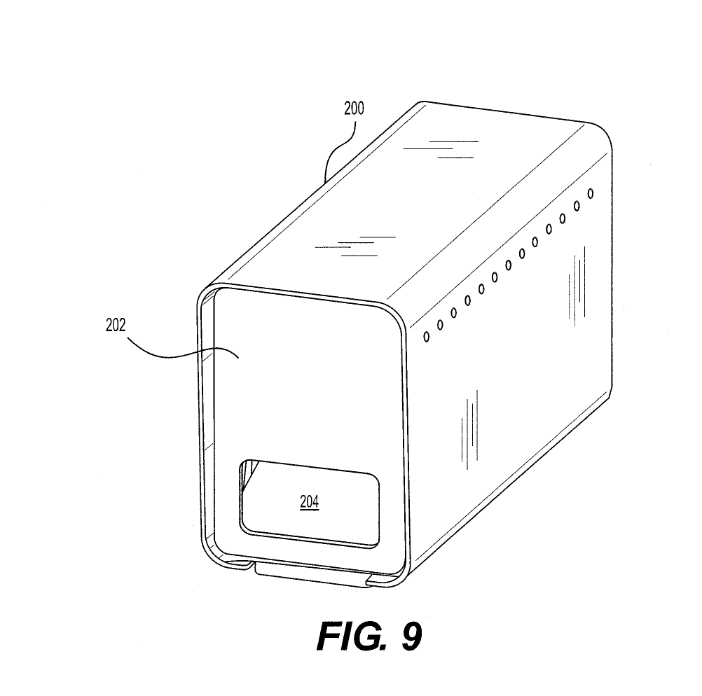

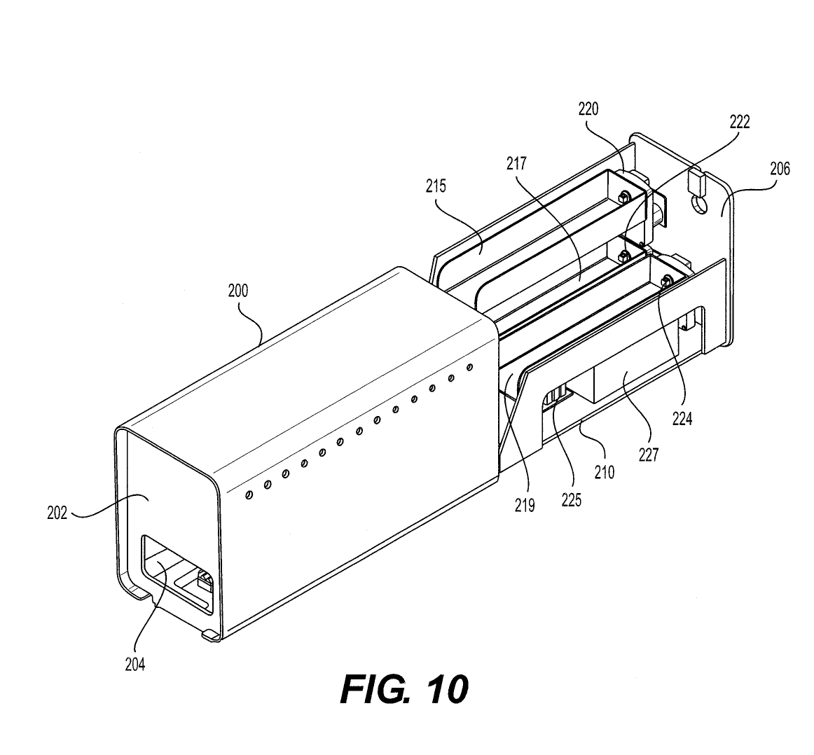

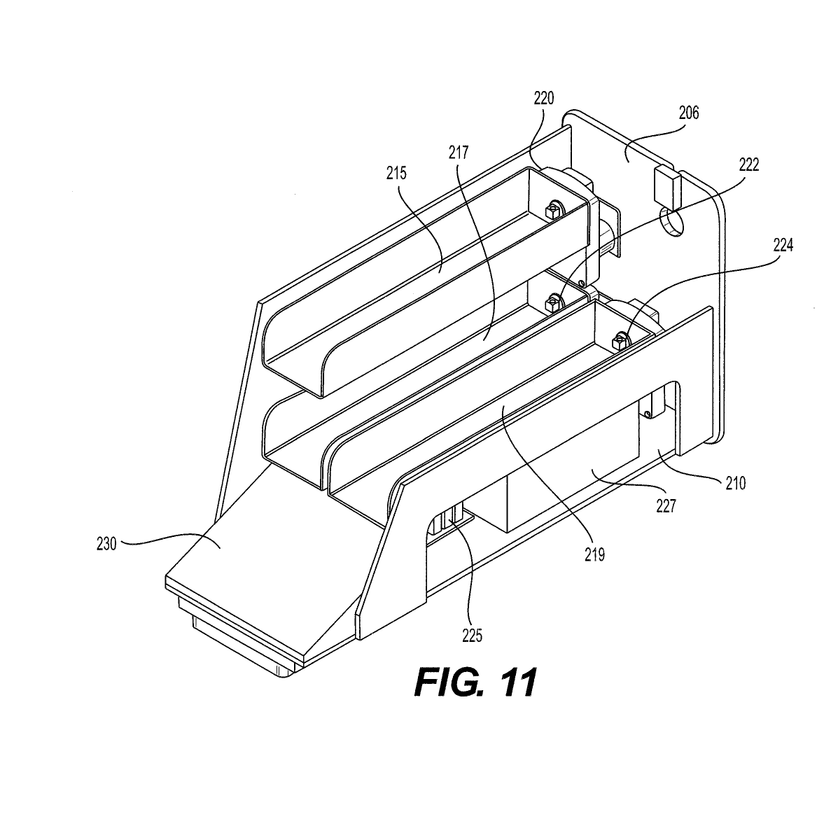

Turning now to FIGS. 9-11, there is illustrated a prototype of a vending machine (200) that stores and dispenses only a small number of different products. The vending machine (200) might be envisioned for use in a low traffic location, even an individual user home or apartment, where a limited number of options for products are needed. The vending machine (200) is formed of a metal case material. The front panel (202) of the machine (200) is an opaque panel that includes an access port (204) that is an opening where a user may gain access to products being dispensed. In FIGS. 10 and 11, the drawer (210) is shown inserted into the case (200). The drawer (210) includes the back panel (206) of the case (200). Three separate troughs (215, 217 and 219) are shown. Each of these troughs (215, 217 and 219) could hold a different product that may be supported in a spiral auger (not shown) that is rotated by a motor nut (220, 222 and 224) respectively. A machine controller (225) is powered by a battery (227). The controller (225) is actuated as shown, for instance, in a process like that outlined in FIGS. 7 and 8, to rotate an auger screw with the motor nuts (220, 222 and 224). Product will then be pushed forward and dropped down onto a slide (230) which makes the product then available for pick up in the access port (204). Again, it is envisioned that the vending machine described herein can be used to store and offer for sale multiple items, typically more than just three items as shown in this prototype example (200).

There are many applications for the present invention. One application is the distribution of controlled substances without immediate and real-time authorization of the purchase by a person. Examples of the types of controlled substances distributed include tobacco products, alcohol, medications, and firearm ammunition. All of these products may have different rules allowing or restricting their distribution. Tobacco and alcohol products are age restricted. Some medications are purchase rate restricted. Some medications require a physician prescription for purchase. In each of these situations the vending services can apply the rules specific to the products within the machine to limit purchases to only authorized items.

In an example built to distribute tobacco products, the vending services apply age specific rules to the registered users to determine eligibility to see and purchase product.

In an example built to distribute non-prescription medications, the vending services examine prior purchase history to verify that the user has not exceeded federal limits on the amount of medications that can be purchased. For prescription medications, a prescribing physician system provides a secure token containing the prescription. This token is then provided by the system to a vending machine proximate to the user authorizing the distribution of the medication.

Another example of the invention can allow for parental approval of purchases either before a purchase or in real-time with the purchase. In this embodiment the system relates a child mobile computer with the parent mobile computer. When the child requests a product from a machine the system sends a notification to the parent mobile computer requesting real-time authorization of the purchase. Alternatively, the parent may use their mobile computer to pre-authorize purchases for their child.

An alternate example of this invention can be a machine in a private residence that controls the distribution of medications. The machine secures the medications from access by unauthorized 3^{rd} parties.

An example of this invention can be a machine used at concert or event venues to distribute controlled substances, such as alcohol. Event attendees may receive tokens for a specific amount of drinks. They can then redeem those tokens at automated vending machines to receive the controlled product.

A further example is the use of the machine within a work environment to distribute high-value consumables to employees.

Other embodiments of the present invention will be apparent to those skilled in the art from consideration of the specification. It is intended that the specification and figures be considered as exemplary only, with a true scope and spirit of the invention being indicated by the following claims.

What is claimed is:

1. A vending machine system for enabling the purchase and delivery of rules-restricted merchandise, the system comprising:
a vending machine and a mobile device;
the vending machine comprising a secure cabinet having merchandise stored therein, wherein the merchandise comprises rules-restricted merchandise that is not visible from the outside of the cabinet;
the cabinet comprising a controller, a dispensing mechanism and an access port, wherein the controller is adapted to actuate the dispensing mechanism to transfer merchandise from inside the cabinet to the access port, wherein the access port is open to the outside of the cabinet;
wherein the controller comprises a transceiver adapted to transmit and receive wireless communication signals;
the mobile device comprises an electronic unique identifier that includes an authorization for eligibility to purchase the rules-restricted merchandise;
the mobile device comprising a user interface and a transceiver adapted to transmit and receive wireless communication signals;
wherein the controller and the mobile device are wirelessly connected to exchange communication signals;
and further wherein the controller is adapted to dispense rules-restricted merchandise to the access port upon confirmation of receipt of an eligibility signal from the mobile device.

2. A vending machine system as described in claim 1, the system further comprising:
a service orchestrator that is operatively linked to the mobile device and/or to the vending machine, wherein the service orchestrator comprises a transceiver for exchanging communication signals with the mobile device and/or the vending machine controller;
and wherein the service orchestrator comprises a payment engine that records and authorizes by a communications signal the financial payment for vending machine merchandise by the mobile device.

3. A vending machine system as described in claim 2,
wherein the vending machine controller comprises a merchandise inventory record, and the merchandise inventory record is transmitted to and stored in the service orchestrator.

4. A vending machine system as described in claim 2,
wherein the service orchestrator comprises a location service engine that is adapted to communicate with the mobile device to deliver location information regarding the vending machine to the mobile device.

5. A vending machine system as described in claim 2,
wherein the service orchestrator comprises an eligibility engine, wherein the eligibility engine comprises a record of electronic unique identifiers and their corresponding authorization for the purchase of rules-restricted merchandise.

6. A vending machine system as described in claim 1,
wherein the mobile device comprises a user interface that displays merchandise in the vending machine that is available for sale to a user of the mobile device.

7. A vending machine system as described in claim 2,
wherein the service orchestrator is operatively linked to both the vending machine and the mobile device.

8. A vending machine system as described in claim 1,
wherein all of the merchandise stored in the vending machine cabinet is rules-restricted merchandise.

9. A vending machine system as described in claim 8,
wherein none of the merchandise in the vending machine cabinet is visible from outside the cabinet.

10. A vending machine system as described in claim 4,
wherein the vending machine controller will only actuate dispensing of merchandise to the access port if the mobile device is proximate the vending machine.

11. A vending machine system as described in claim 1, wherein the vending machine comprises no user interface on the outside surface of the cabinet that relates to a purchase of merchandise stored inside the cabinet.

12. A vending machine system as described in claim 1, wherein the merchandise further comprises unrestricted merchandise.

13. A vending machine system as described in claim 12, wherein the unrestricted merchandise in the vending machine cabinet is visible from outside the cabinet.

14. A vending machine system as described in claim 2, wherein the vending machine controller comprises a vending machine service history and a service dispatcher for monitoring and ordering a service call to the vending machine.

15. A vending machine system as described in claim 1, wherein the vending machine comprises a dispensing sensor that validates that a customer has received the dispensed merchandise.

16. A vending machine system as described in claim 15, wherein the sensor is selected from the group consisting of a motion sensor, a camera, a heat sensor, a weight scale, and a door open sensor.

17. A vending machine system for enabling the purchase and delivery of rules-restricted merchandise, the system comprising:
a vending machine and a mobile device;
the vending machine comprising a secure cabinet having merchandise stored therein, wherein the merchandise comprises rules-restricted merchandise that is not visible from the outside of the cabinet;
the cabinet comprising a controller, a dispensing mechanism and an access port, wherein the controller is adapted to actuate the dispensing mechanism to transfer merchandise from inside the cabinet to the access port, wherein the access port is open to the outside of the cabinet;
wherein the controller comprises a transceiver adapted to transmit and receive wireless communication signals;
the mobile device comprises an electronic unique identifier that includes an authorization for eligibility to purchase the rules-restricted merchandise;
the mobile device comprising a user interface and a transceiver adapted to transmit and receive wireless communication signals;
a service orchestrator that is operatively linked to the mobile device and to the vending machine, wherein the service orchestrator comprises a transceiver for exchanging communication signals with the mobile device and the vending machine controller;
wherein the controller and the mobile device are each connected and communicate with each other through the service orchestrator;
and further wherein the controller is adapted to dispense rules-restricted merchandise to the access port upon confirmation of receipt of an eligibility signal from the mobile device.

18. A vending machine system as described in claim 17, wherein the service orchestrator comprises a payment engine that records and authorizes by a communications signal the financial payment for vending machine merchandise by the mobile device.

19. A vending machine system as described in claim 17,
wherein the service orchestrator comprises a location service engine that is adapted to communicate with the mobile device to deliver location information regarding the vending machine to the mobile device.
